(19) United States
(12) Patent Application Publication
(10) Pub. No.: US 2007/0053773 A1
(43) Pub. Date: Mar. 8, 2007

(54) Integrated nozzle wheel for reaction steam turbine stationary components and related method

(75) Inventors: John Thomas Murphy, Niskayuna, NY (US); Stephen Swan, Clifton Park, NY (US); Robert James Bracken, Niskayuna, NY (US); Jeffrey R. Simkins, Rensselaer, NY (US); Clement Gazzillo, Schenectady, NY (US); David Orus Fitts, Ballston Spa, NY (US); Mark William Kowalczyk, Amsterdam, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/219,667

(22) Filed: Sep. 7, 2005

(51) Int. Cl. F03B 1/04

(52) U.S. Cl. 415/202

(57) ABSTRACT

An integrated nozzle wheel for a turbine stator component includes a three hundred sixty degree wheel formed from a single piece of stock material, a radially inner portion of the wheel machined to include a plurality of nozzles, each having an airfoil portion and a radially inner tip shroud portion; a radially outer portion of the wheel machined to include one or more assembly features.

### BACKGROUND OF THE INVENTION

This invention relates generally to steam turbine construction and, more specifically, to an integrated nozzle wheel construction for a reaction steam turbine.

Current integral-cover reaction nozzle stages are made up of large quantities of individual reaction nozzles that are assembled into a machined stator casting or nozzle carrier. More specifically, individual nozzles are loaded into a dovetail groove and secured within the carrier using individual radial loading pins. Each nozzle tip is machined with a specified tip seal configuration for interaction with the turbine rotor so as to minimize leakage along the hot gas path. The time and cost associated with the manufacture of the stator casting, stator machining, nozzle stock material, nozzle machining and stator assembly add significant costs overall to the reaction steam path.

### BRIEF DESCRIPTION OF THE INVENTION

In accordance with an exemplary embodiment of this invention, the nozzle manufacturing/assembly process is simplified, and the overall cost of the reaction steam path is reduced without impacting the integrity of the overall reaction steam turbine design.

In the exemplary embodiment, a full row of reaction nozzles is machined into a 360° piece of flat stock material. It will be understood that the stock material may be forged, rolled ring or plate stock. The 360° ring is placed into a machining center where the ID, OD, inlet blends, airfoils, airfoil radii, cover shroud sealing configuration, retention features and the balance of the standard nozzle features are machined. Thereafter, the integrated nozzle wheel may or may not be split into two or more arcuate segments in preparation for the final steam path assembly process.

It is also possible to incorporate into the integrated nozzle wheel, adjacent stator surfaces that are forward and/or aft of the nozzle airfoils and utilized to facilitate axial stacking of plural nozzle wheels in an alternating arrangement with rotor stage wheels.

Accordingly, in one aspect, the present invention relates to an integrated nozzle wheel for a turbine stator component comprising a three hundred sixty degree wheel formed from a single piece of stock material, a radially inner portion of the wheel machined to include a plurality of nozzles, each having an airfoil portion and a radially inner tip shroud portion; a radially outer portion of the wheel machined to include one or more assembly features.

In another aspect, the invention relates to an integrated nozzle wheel for a turbine stator component comprising a three hundred sixty degree wheel formed from a single piece of stock material, a radially inner portion of the wheel machined to include a plurality of nozzles, each having an airfoil portion and a radially inner tip shroud portion; an outer portion of the wheel machined to include one or more assembly features; wherein the outer portion is formed with a plurality of bolt holes; wherein the bolt holes are circumferentially spaced about the outer portion; and wherein the wheel is split into two or more arcuate segments.

In still another aspect, the invention relates to a turbine stator comprising a plurality of nozzle wheels assembled within a turbine casing, the nozzle wheels and the turbine casing split into upper and lower components, respectively, each nozzle wheel comprising a three hundred sixty degree wheel formed from a single piece of stock material, a radially inner portion of each nozzle wheel machined to include a plurality of nozzles; a radially outer portion of the wheel machined to include one or more assembly features.

In still another aspect, the invention relates to a method of making a turbine nozzle wheel comprising forming flat stock material into an annular ring; machining a radially inner portion of the annular ring to include a plurality of nozzles, each having an airfoil portion, and a radially outer portion of the annular ring to include assembly features.

The invention will now be described in detail in connection with the drawings identified below.

### BRIEF DESCRIPTION OF THE DRAWINGS

FIG. 1 is a perspective view of an integrated nozzle wheel in accordance with an exemplary embodiment of the invention;

FIG. 2 is a perspective view of another integrated nozzle wheel in accordance with the invention;

FIG. 3 is a perspective view of the nozzle wheel of FIG. 1 assembled in a lower turbine casing component; and

FIG. 4 is a perspective view similar to FIG. 3, but with an upper turbine casing component located over the upper nozzle wheel segment.

### DETAILED DESCRIPTION OF THE INVENTION

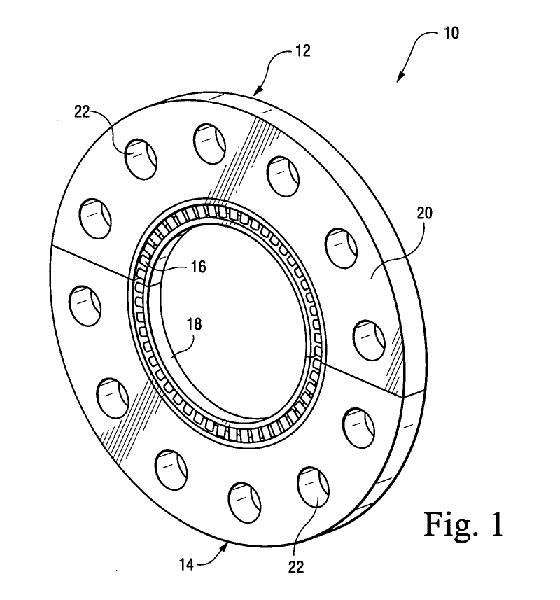

With initial reference to FIG. 1, an integrated nozzle wheel 10 is shown, split into upper and lower 180° segments or halves 12, 14. It will be appreciated that splitting the wheel facilitates assembly in the upper and lower turbine casing components or sections, with the nozzle wheel segments surrounding the rotor.

In the exemplary embodiment, the wheel 10 is manufactured from a single 360° piece of flat stock material that could be forged, rolled ring or plate stock. The annular ring is thereafter machined to include a plurality of airfoils 16, in a circumferential array at the radially inner portion of the wheel. The radially inner ends of the airfoils 16 are also machined to include an integral cover shroud sealing configuration 18 that determines the ID of the wheel. The remainder of the wheel, specifically the radially outer portion 20, is formed to include assembly bolt or tie-rod holes 22 and any other rim or rabbet configuration to facilitate axial stacking with similar wheels, or with discrete spacer rings therebetween that accommodate the rotating stages on the rotor.

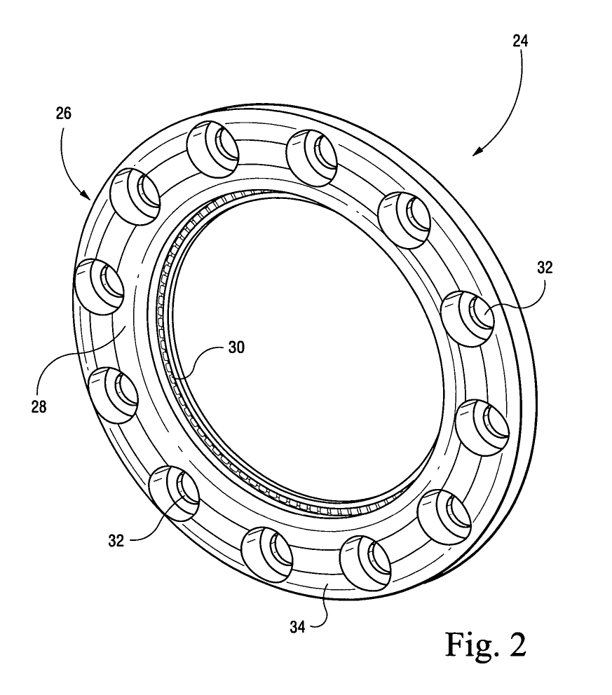

FIG. 2 illustrates another integrated nozzle wheel 24 where one side 26 of the wheel is machined to include a blended toroidal-shaped inlet 28 extending axially upstream of the integrated nozzles 30. Here again, bolt or tie-rod holes 32 are provided in the radially outer region 34 to facilitate axial stacking.

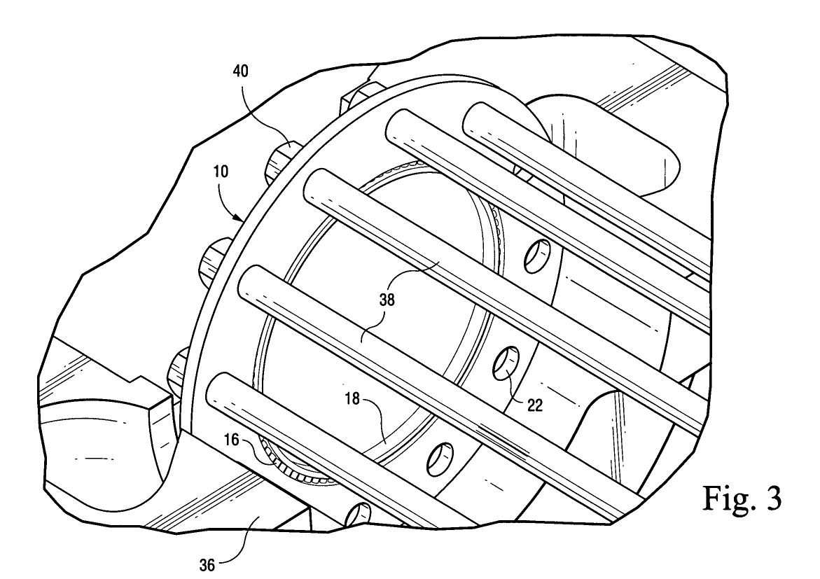

FIG. 3 illustrates the nozzle wheel 10 of FIG. 1 located in a lower turbine casing component 36 with a plurality of tie rods or bolts 38 extending through the holes 22 and secured by nuts 40 or the like to facilitate axial stacking of multiple nozzle wheels.

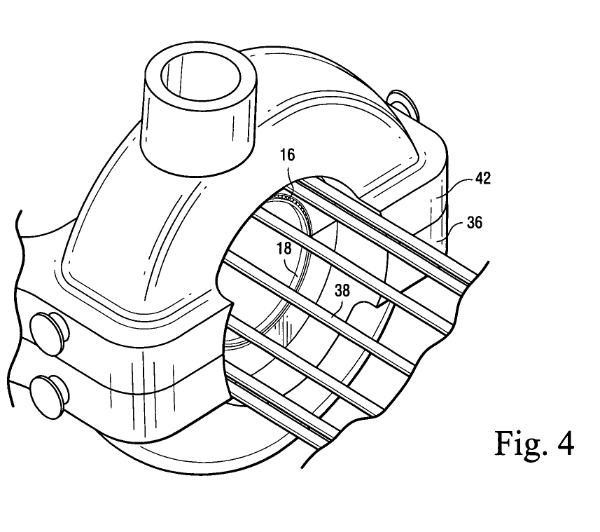

FIG. 4 illustrates the arrangement in FIG. 3 but with an upper casing component 42 assembled over the lower casing component 32. It will be appreciated that the upper and lower nozzle wheel segments 12, 14 and the upper and lower casing components 36, 42 will be secured, respectively, to each other, using conventional retention/securement hardware configurations (not shown). In the case of the nozzle wheel segments, the retention/securement features will be machined into the segments consistent with the invention described herein.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An integrated nozzle wheel for a turbine stator component comprising a three hundred sixty degree wheel formed from a single piece of stock material, a radially inner portion of said wheel manufactured to include a plurality of nozzles, each having an airfoil portion and a radially inner tip shroud portion; a radially outer portion of said wheel manufactured to include one or more assembly features.

2. The integrated nozzle wheel of claim 1 wherein said assembly features include a plurality of tie-rod or bolt holes.

3. The integrated nozzle wheel of claim 2 wherein said tie-rod or bolt holes are circumferentially spaced about said radially outer portion.

4. The integrated nozzle wheel of claim 1 wherein said wheel is split into two or more arcuate segments.

5. The integrated nozzle wheel of claim 1 wherein said stock material comprises a forged stock.

6. The integrated nozzle wheel of claim 1 wherein said stock material comprises rolled ring stock.

7. The integrated nozzle wheel of claim 1 wherein said stock material comprises generally flat plate stock.

8. An integrated nozzle wheel for a turbine stator component comprising a three hundred sixty degree wheel formed from a single piece of stock material, a radially inner portion of said wheel machined to include a plurality of nozzles, each having an airfoil portion and a radially inner tip shroud portion; an outer portion of said wheel machined to include a plurality of tie-rod or bolt holes circumferentially spaced about said outer portion; and wherein said wheel is split into a pair of 180° arcuate segments.

9. A method of making a turbine nozzle wheel comprising forming stock material into an annular ring; machining a radially inner portion of said annular ring to include a plurality of nozzles, each having an airfoil portion, and a radially outer portion of said annular ring to include assembly features.

10. The method of claim 9 wherein said assembly features include a plurality of circumferentially spaced tie-rod or bolt holes.

11. The method of claim 9 including machining shroud covers on radially inner tips of said nozzle/airfoil portions.
